(19) United States
(12) Patent Application Publication
(10) Pub. No.: US 2024/0311731 A1
(43) Pub. Date: Sep. 19, 2024

(54) LOGISTICS SAFETY OPERATIONS

(71) Applicant: Dell Products L.P., Round Rock, TX (US)

(72) Inventors: Eric L. Caron, Ottawa (CA); Vinicius Michel Gottin, Rio de Janeiro (BR); Jason Bonafide, Winter Garden, FL (US); Nalinkumar Mistry, Ottawa (CA)

(21) Appl. No.: 18/185,524

(22) Filed: Mar. 17, 2023

(51) Int. Cl. G06Q 10/0635; G06Q 50/28; G06V 20/52

(52) U.S. Cl. CPC G06Q 10/0635; G06Q 10/08; G06V 20/52

(57) ABSTRACT

Digital twin-based logistics operations are disclosed. A digital twin virtual environment models a physical environment and includes virtual nodes and virtual sensors that have corresponding physical nodes and physical sensors in the physical environment. Positions of the nodes are tracked in the digital twin. Using position data and other sensor data, the digital twin can be used to train machine learning models, label data for training, aggregate data, generate warnings, and cause a real or virtual display to be displayed when an event is predicted or determined.

### FIELD OF THE INVENTION

This application is related to U.S. Ser. No. 17/813,209 filed Jul. 18, 2022, and titled “EVENT DETECTION OF FAR EDGE MOBILE DEVICES USING DELAYED POSITIONING DATA”, which is incorporated by reference in its entirely.

### FIELD OF THE INVENTION

Embodiments of the present invention generally relate to logistics, logistics operations, and digital twins. More particularly, at least some embodiments of the invention relate to systems, hardware, software, computer-readable media, and methods for performing digital twin based logistics operations.

### BACKGROUND

Logistics operations are an important aspect of many environments. Many environments, such as warehouse environments, often have multiple devices operating therein, some or all of which may be automated. Consequently, there is a need to ensure that the devices operate in a safe manner. For example, collisions are a safety concern and attempts to avoid collisions should be performed. The likelihood of a collision may be based on the positions and/or trajectories of the devices operating in the warehouse environment.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of an environment that includes a near edge environment;

FIG. 1B discloses aspects of a far edge environment in an environment;

FIG. 2A discloses aspects of a digital twin environment;

FIG. 2B discloses additional aspects of a digital twin environment;

FIG. 3A discloses aspects of logistics operations using a digital twin from a perspective of a far edge node;

FIG. 3B discloses aspects of logistics operations using a digital twin from a perspective of a near edge node;

FIG. 4A discloses aspects of a virtual environment;

FIG. 4B discloses aspects of a virtual environment that includes rendered data;

FIG. 5 discloses aspects of digital twin-based logistics operations; and

FIG. 6 discloses aspects of a computing device, system, or entity.

### DETAILED DESCRIPTION OF SOME EXAMPLE EMBODIMENTS

Embodiments of the present invention generally relate to logistics and logistics operations. More particularly, at least some embodiments of the invention relate to systems, hardware, software, computer-readable media, and methods for performing digital twin-based logistics operations, which include safety operations.

Embodiments of the invention thus relate to logistics operations that may be performed with respect to an environment such as a warehouse that is modeled using a digital twin. Multiple devices, such as forklifts, automated mobile robots (AMRs), and the like may operate in the environment. Embodiments of the invention relate to performing digital twin-based logistics operations for devices operating in these types of environments.

Logistics operations may benefit from machine learning models that can predict the trajectories of the devices and unsafe or potentially unsafe conditions using the captured data. More specifically, the data collected/received from the devices may be used in predicting and preventing collisions and other dangerous situations.

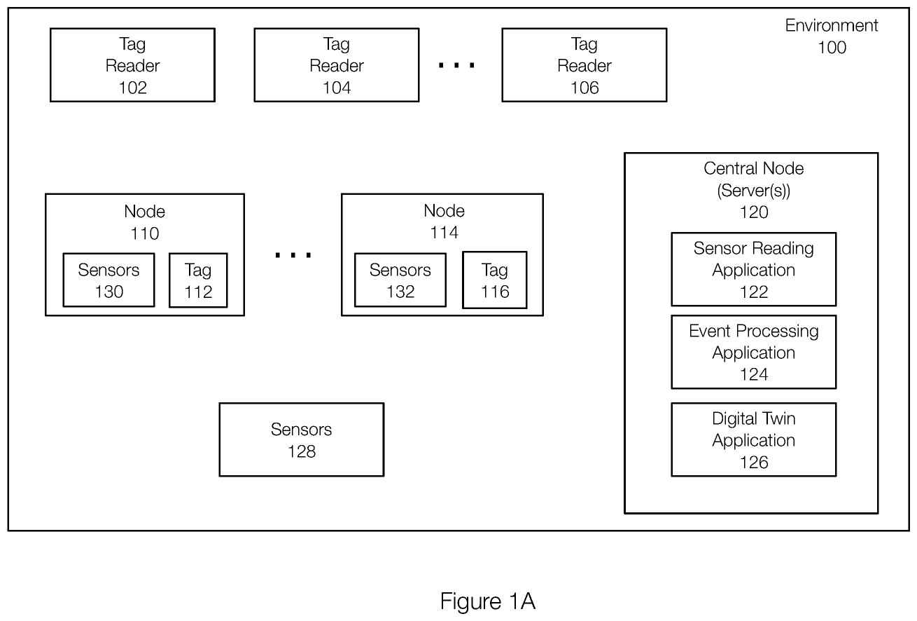

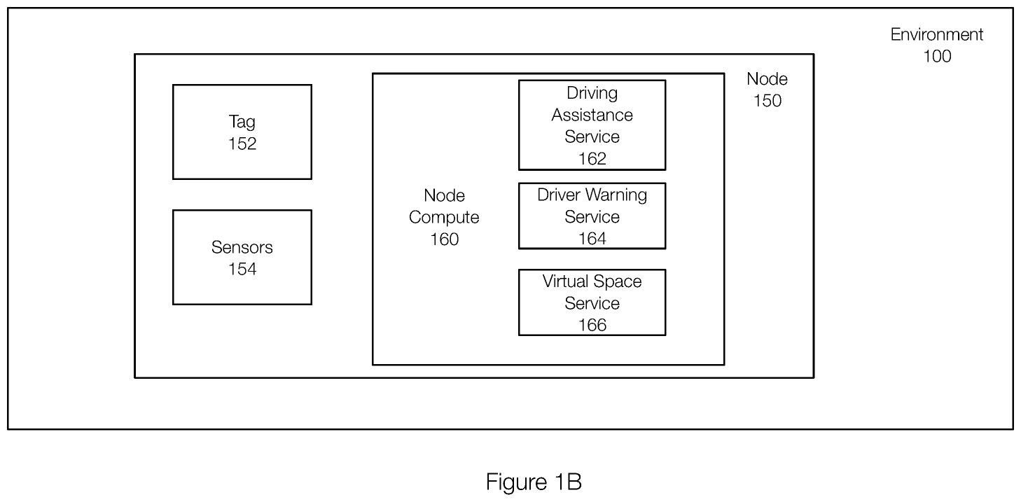

FIGS. 1A and 1B disclose aspects of an environment including a near edge environment and a far edge environment. FIG. 1A more specifically illustrates an environment 100 that includes a central node 120. The central node 120 is an example of a near edge system, environment and may be referred to as a near edge node. The central node 120 is configured with computing resources such as processors, memory, and networking hardware. The central node 120 may be located in the environment 100, cloud-based, or the like.

The environment 100, which may be a warehouse, may house a number of mobile devices (forklifts, AMRs, etc.), which are represented by nodes 110 and 114. The environment 100 also includes ultra-wideband (UWB) readers, Radio Frequency Identification (RFID) readers, or the like, which are represented by tag readers 102, 104, and 106. The tag readers 102, 104, and 106 may be placed in various locations in the environment 100.

The nodes 110 and 114 may include or be associated with tags, represented by tags 112 and 116, such as UWB tags and/or RFID tags. The environment 100 may include other sensors 128. Example sensors 128 include cameras, microphones, motion sensors, or the like or combination thereof. The tag readers 102, 104, and 106 may also be referred to as sensors.

In addition to the tags 112 and 116, the nodes 110 and 114 may also include sensors 130 and 132. The sensors 130 and 132 may include inertial sensors, position sensors, or the like. The tags 114 and 116 may also be examples of sensors.

The central node 120 is configured with services or applications that may be configured to extract/collect/receive and manage sensor data. For example, the central node 120 may receive data from the tag readers 102, 104 and 106 and/or from the nodes 110 and 114 and/or data from the tags 112 and 116 and/or the sensors 130 and 132 placed on the nodes 110 and 114. This data may be processed by services or applications such as, by way of example, a sensor reading application 122, an event processing application 124, and a digital twin application 126.

For example, the tag reader 102 and the tag 112, when within range, may coordinate to determine a position of the node 110. This position can be transmitted to the central node 120. This position data allows positions of the nodes 110 and 114 in the environment 100 to be determined and tracked over time. Generally, UWB has a range of 0-50 meters and a latency that is typically less than 1 millisecond. Consequently, the positions of the nodes 110 and 114 can be captured in substantially real time.

FIG. 1B discloses aspects of a far edge node or environment. More specifically, FIG. 1B discloses additional aspects of nodes operating in the environment 100. In this example, the mobile devices or nodes are examples of a far edge environment and FIG. 1B discloses aspects of a node 150. The node 150 is an example of a mobile device and/or computing resources of a mobile device operating in the environment 100. FIG. 1B illustrates a node 150, which is similar to the nodes 110 and 114. In this example, the node compute 160 may also include services or applications such as a driving assistance service 162, a driver warning service 164, and a virtual space service 166. The node compute 160 may include processors, memory, and networking hardware.

The node 150 may also include a tag 152 that can be read/cooperate by/with a tag reader and sensors 154, which may generate data. Example sensors 154 include inertial sensors, position sensors, proximity sensors, or the like. The sensors 154 may be dependent on the characteristics of the node 150. If the node 150 corresponds to a forklift, for example, other sensors may include a load weight sensor, a mast height sensor, or the like.

The services 162, 164, and 166 may publish positioning data, subscribe to event topics to warn the driver or node regarding safety issues (e.g., collision scenarios), and the like.

Embodiments of the invention relate to modeling an environment, such as the environment 100. The digital twin may be configured to reflect aspects of the environment such as doors, shelves, columns, or the like. The digital twin may also represent each node (each device) operating in the environment. As positions of the nodes are updated, the corresponding virtual node's position is updated in the digital twin.

More generally, a digital twin, generally, is a digital model of a physical system. In this case, the digital twin may include a virtual model of the warehouse environment, the nodes operating in the warehouse, and other aspects of the warehouse. The digital twin can model the environment in three dimensions and can model fixtures (e.g., shelves, columns, doors) of the environment. The digital twin may be able to actuate real sensors in the physical environment, virtual sensors in the virtual environment, perform tests using real and/or synthetic data, verify the accuracy of machine learning models, test machine learning models, or the like.

As discussed herein, the real environment may be referred to as the physical environment (or environment) and the digital twin environment may be referred to as a virtual environment or digital twin environment.

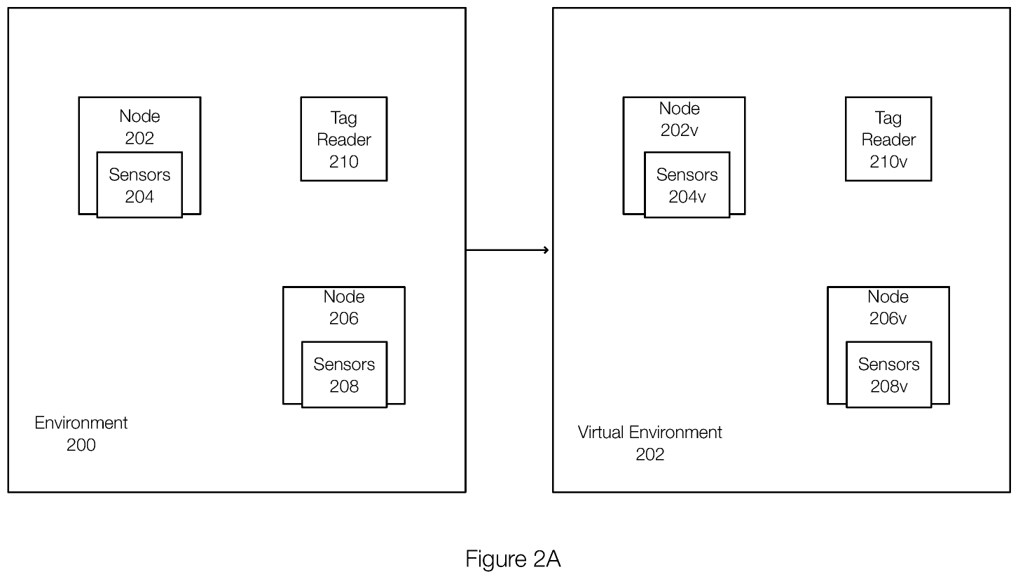

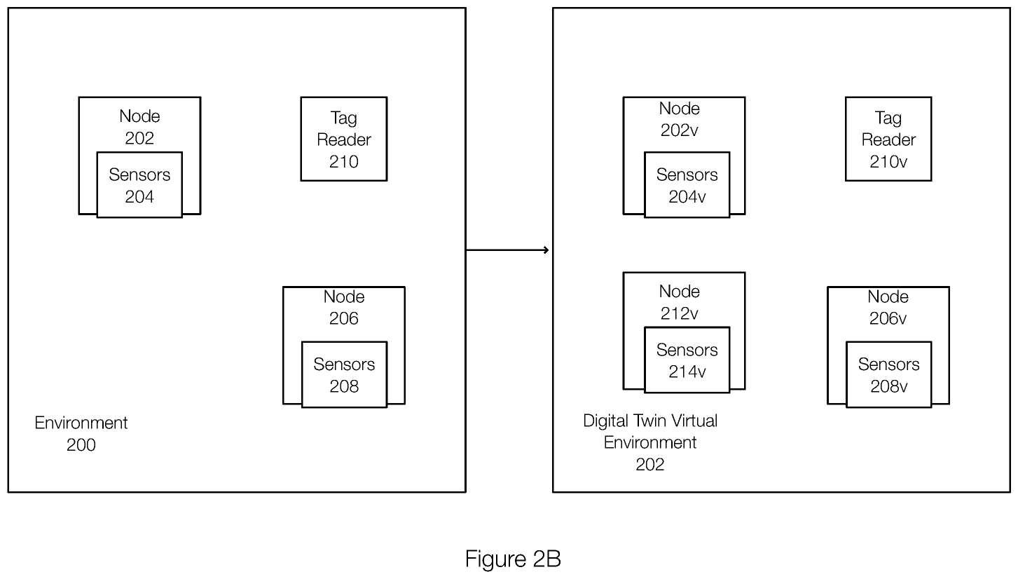

FIG. 2A discloses aspects of a digital twin environment. FIG. 2A illustrates an environment 200 and a corresponding virtual environment 202 that is a model of the environment 200. Devices in the environment 200 include a node 202 associated with sensors 204, a node 206 associated with sensors 208, and a tag reader 210. These devices are modeled in the virtual environment 202 as a virtual node 202v with virtual sensors 204v, a virtual node 206v with virtual sensors 208v, and a virtual tag reader 210v.

The environment 200 may include any number of devices, tags, and other structure and the digital twin virtual environment 202 can virtually represent the devices, tags, and other structure.

FIG. 2B discloses additional aspects of a virtual environment. FIG. 2B is similar to FIG. 2A. However, an additional virtual node 212v with virtual sensors 214v is represented in the virtual environment 202. The node 212v does not correspond to a physical device or node in the environment 200. However, the node 212v can be modeled to include virtual sensors 214v such as virtual inertial sensors, virtual RFID tags, virtual UWB tags (like other nodes). These virtual sensors 214v and the virtual node 212v can be modelled and actuated as if present in the environment 200. The virtual environment 202 can be used for testing purposes and warehouses. The environment 202 may also be used to test/verify new warehouse designs including logistic rules, sensor/reader placement, camera placement, or the like or combinations thereof. For example, the node 212v, which does not have a physical counterpart, can test the efficiency of a machine learning model configured to detect a collision, a dangerous cornering, or the like. If the node 212v is moved toward the node 202 (the node 202v in the virtual environment), data generated by the virtual sensors 214v and/or the sensors 204 can be used to determine whether the machine learning model will detect a potential collision and test the ability to generate alerts or perform other logistics operations.

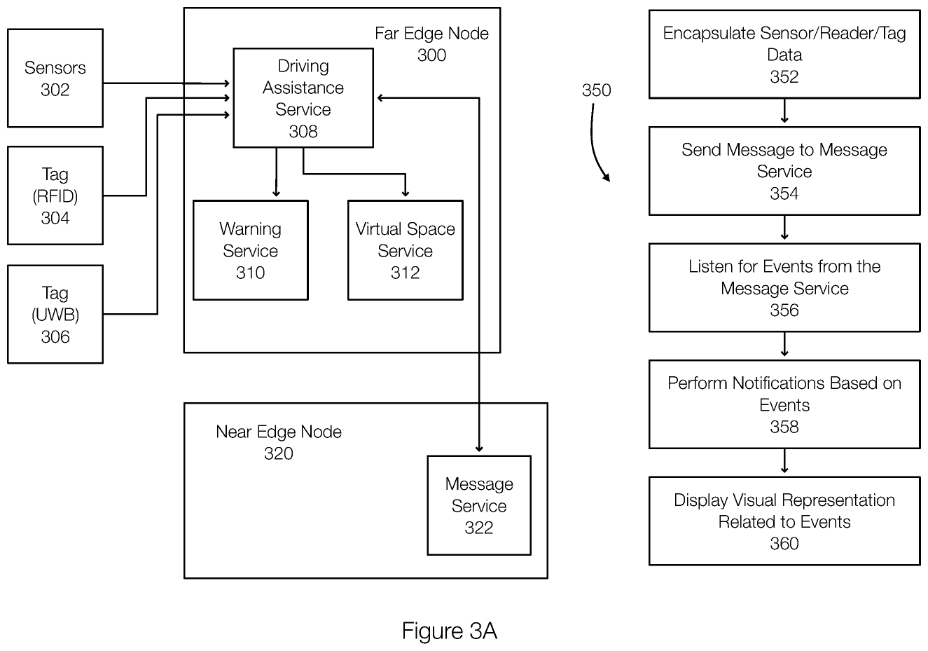

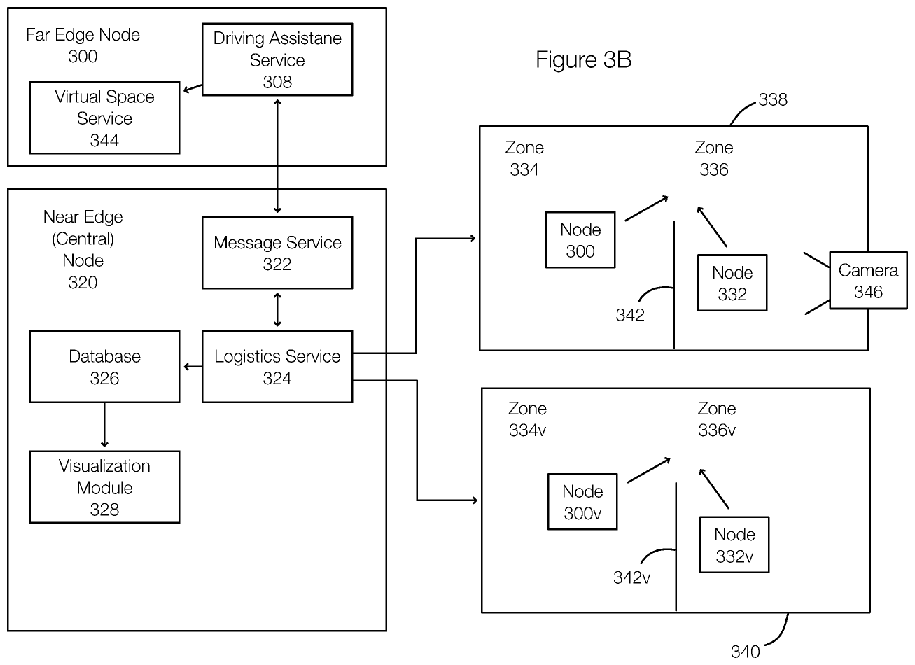

FIGS. 3A and 3B disclose aspects of logistics operations using digital twins. FIG. 3A illustrates aspects of logistics operations performed at or from the perspective of a far edge node 300 (e.g., a forklift, AMR). The node 300, by way of example, may be equipped with sensors 302, which represents one or more sensors including an IMU (Inertial Measurement Unit) sensor. The node 300 may also be associated with other sensors such as a tag 304 (an RFID tag) and/or a tag 306 (UWB tag). The tags 304 and 306 may cooperate with corresponding readers to generate information including position information. In one example, the tag 306 may coordinate with a UWB reader to generate a position within an environment that is provided to the driving assistance service 308 operating on the node 300. Similarly, inertial data and RFID data may be provided to the driving assistance service 308.

The data collected by or received from the sensors 302 and the tags 304 and 306 may be transmitted to a message service 322 at a near edge node 320. By transmitting position data, inertial data, or the like to the near edge node 320, the data can be used in downstream capacities and applications including a digital twin application. The data from the sensors 302 may also be used locally at the node 300. For example, the data may be input to machine learning models to generate inferences or predictions that may be related to logistics, such as collision avoidance.

Thus, the driving assistance service 308 may transmit data (e.g., events over a message bus or wireless connection) to the message service 322. The driving assistance service 308 may also listen to or receive messages from the message service 322. When the driving assistance service 308 receives events or messages from the message service, the driving assistance service 308 may respond to events received from the message service 322. For example, the driving assistance service 308 may cause the warning service 310 to issue a warning to a driver. The driving assistant service 308 may use the virtual space service 312 to present data to a driver (e.g., visually, audibly, textually). More specifically, the virtual space service 312 may be configured to display to a driver or other user, on a display, aspects of the environment. The displayed data may be real (e.g., a frame from a physical camera) or virtual data (e.g., a rendering of the environment based on the digital twin). In one example, events received from the message service 322 may also be input to machine learning models at the node 300.

FIG. 3A further illustrates a method 350 associated with operation of the node 300. The node 300 (e.g., the driving assistance service 308) may encapsulate data from the sensors 302, the tag 304 and/or the tag 306. The encapsulated data may include positioning data, inertial data, or the like. For example, UWB tag 306 may generate position data indicative of the position of the node 300. The position data may have accuracy of 10-50 cm in one embodiment.

The encapsulated data (or simply data from the sensors 302, the tag 304, and/or the tag 306) may be transmitted or sent 354 to the message service 322 as an event. The driving assistance service 308 may also listen 356 for events from the message service.

The driving assistance service 308 may include or have access to a machine learning model. Using events received from the message service 322 and/or data from the sensors 302, the tag 304, and/or the tag 306, the driving assistance may generate predictions, such as a potential collision or dangerous cornering. The machine learning model may, in other embodiments, be located at the near edge node 320 such that events transmitted to the node 300 may constitute warnings or the like that can be conveyed to the user via a warning service 310. In one example, the machine learning model may be incorporated into the digital twin application. This is possible, in part, due to the very low delay associated with positioning from the tag 306. If there is not enough historical data to train the machine learning model, embodiments of the invention, including the digital twin, may model geographic zones within the warehouse environment. These zones can be marked as dangerous when a node is operating therein. Nodes entering a dangerous zone may receive a warning that another node is nearby (within the same geographic zone). Thus, whether using geo-zones or machine learning models, the warning service 310 may be invoked, which in turn generates an alert of some type.

In one example, the events communicated from the message service 322 to the driving assistance service 308 may be used to respond visually using the virtual space service 312. The virtual space service 312 may show a view of a particular zone that could, for example, be related to a live camera display capturing the zone. The camera, via the digital twin, can be actuated based on events that relate back to sensors in the actual environment and/or geo-zones defined in the digital twin environment. This representation can be displayed 360 on a display device to a driver or other entity. Alternatively, the representation may be a virtual reconstruction of the zone to graphically illustrate relative positions of other nodes in the zone or other area.

FIG. 3B discloses aspects of a near edge or central node. FIG. 3B illustrates aspects of digital-twin based logistics from the perspective of the near edge or central node 320 while FIG. 3A illustrates aspects of digital-twin based logistics from the perspective of the far edge node 300.

In FIG. 3B, the central node 320 includes the message service 322. The message service 322 may communicate events between the computing resources of the node 320 and the far edge node 300. Events received at the message service 322 from the node 300 (or the driving assistance service 308) may include position data such as UWB positioning data.

The digital twin application 126, which may include the logistics service 324, may listen for events via the message service 322. These events are used by the logistics service 324 to keep a virtual environment 340 synchronized with a physical environment 338. For example, the node 300 may move in the physical environment 338. The driving assistance service 308, may send UWB position data to the message service 322 as an event. The logistics service 324 may update the position of the virtual node 300v in the virtual environment 340. As previously stated, embodiments of the invention are not limited to UWB positioning data. Rather, the logistics service 324 may actuate or update virtual nodes/devices that exist in the virtual environment 340 as real-world events occur or are received at the digital twin. The logistics service 324 may be configured to illustrate events that occur and to illustrated the specific nodes (or devices) and/or sensors that are associated with the event and/or their associated readings (sensor/tag data). The logistics service 324 may present displays or user interfaces on various display, which may include displays on the nodes.

The digital twin application (or the logistics service 324) is configured to form a virtual connection between real world devices (e.g., the far-edge nodes) and sensors that act independently of those nodes (e.g., cameras, UWB readers, RFID readers). The logistics service 324, which may be part of the logistics service 324, is configured to aggregate readings/data/events in the database 326, which may be published via a visualization module 328, which allows these data to be queried, visualized, or used for other downstream applications. Because the positions of these sensors that are independent of the nodes are known, their data can be used, for example, when a node is within a specified distance of those sensors. The visualization module 328 may allow sensors in the environment to be tied to specific nodes based on positional relationships.

FIG. 3B also illustrates an example of a physical environment 338 and a corresponding virtual environment 340. In this example, the node 300 is in a zone 334 and the node 332 is operating in a different zone 336. Thus, virtual counterpoints, node 300v and node 332v, are illustrated respectively in virtual zones 334v, and 336v.

As the nodes 330 and 332 move, their location may be collected, determined, or gathered using RFID and UWB sensor data (the tags). When the node 300 moves from the zone 334 to the zone 336, the virtual space service 344 (of the node 300) may notify the node 300 (or the driver) of the presence of the node 332. Similarly, the node 332 may be advised of the presence of the node 300 in the zone 336. This movement will be tracked and reflected in the virtual environment 340.

In one example, the virtual space service 344 may present a visual representation of the zone 336, either real or virtual. As indicated by the arrows in the environments 338 and 340, the nodes 330 and 332 may be on a collision course, which is reflected in the virtual environment 340. An image, whether acquired from a camera in the physical environment 338 or rendered using in the virtual environment 240 (e.g., using a virtual camera) may be presented on the nodes 300 and 332.

More specifically, the physical environment 338 includes a camera 346. The camera 346 may generate data independently of the nodes 330 and 332. However, the data generated by the camera 346 may be added to the virtual environment 340. Further, the data from the camera 346 can be related to the nodes 300 and 332 based on position or zone.

The visualization module 328 may be configured to display events that may be generated by nodes, including the virtual nodes 330v and 332v. More specifically, the data aggregated by the logistics service 324 may be subject to rules, input to machine learning models, or the like. When an event of interest is identified (e.g., a potential collision), the logistics service 324 may take action to notify the affected nodes/drivers. Further, information may be presented audibly, visually, or the like at the far edge nodes.

Thus, the logistics service 324 may aggregate information from multiple sensors and the nodes 330 and 332. This information can be published over the message bus, such that downstream applications or environments, such as applications or services on the far edge node, can response to these events as previously described.

FIG. 3B further illustrates that a wall 342 (or other structure) is between the zones 334 and 336. The wall is represented virtually as the wall 342v. The position data allows the digital twin application to determine that the nodes 300 and 332 are on a collision course and take appropriate action, such as generating a warning, presenting a display (either real or virtual) to the nodes 300 and 332. The logistics service 324 may cause a display of the zone 336 to be presented to the node 300 such that the node 300 is aware of the node 332, which is behind the wall 342.

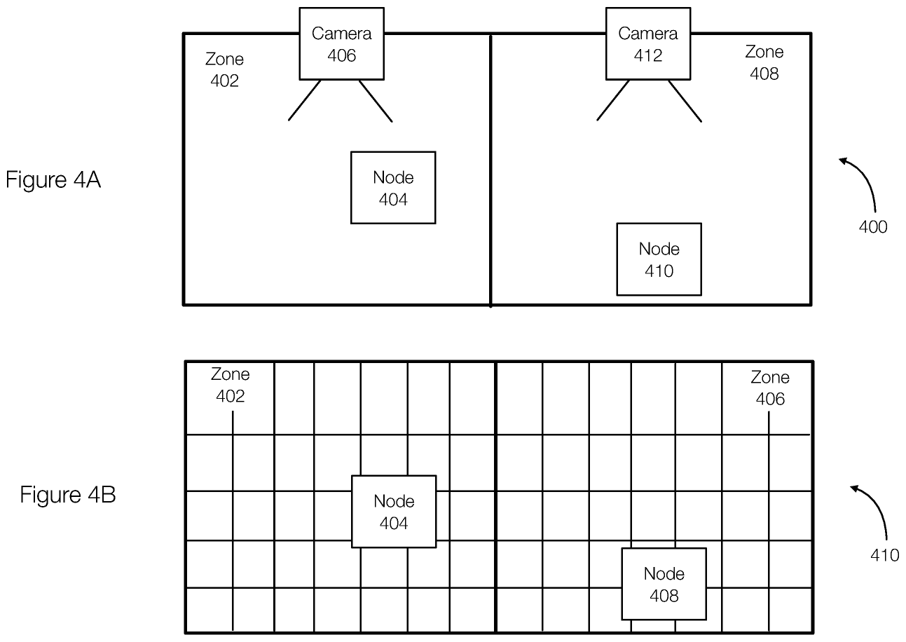

FIGS. 4A and 4B illustrate examples of communications transmitted to a far edge node. FIG. 4A illustrates zones 402 and 408 of an environment. The display 400 may be presented in a display of a far edge node. The zone 402 is associated with a camera 406 and the zone 408 is associated with a camera 412. The display 400 may be a real world display that includes a feed (or frames) from the cameras 406 and/or 412. If the node 404 is entering the zone 408, the camera 412 may be selected and a feed (or frames) from the camera 412 may be provided to the nodes 404 and 410. The camera 412, may be actuated based on events received and processed by the digital twin application. Thus, as the node 404 moves into the zone 412, the camera 412 may be actuated.

FIG. 4B illustrates a rendered display 400. The horizontal and vertical lines may provide a perception of distance or the like. In this example, the rendered display 410 depicts the same nodes 404 and 408 in the same zones 402 and 406. Thus, the rendered display 410 can apprise operators of other nearby nodes.

For example, if the digital twin detects a potential collision or detects that the node 404 is leaving the zone 402 and entering the zone 408, the display 400 or the rendered display 410 may be provided. In one example, a virtual camera may be actuated to provide a view of the zone 406. Additional warnings may be provided as well.

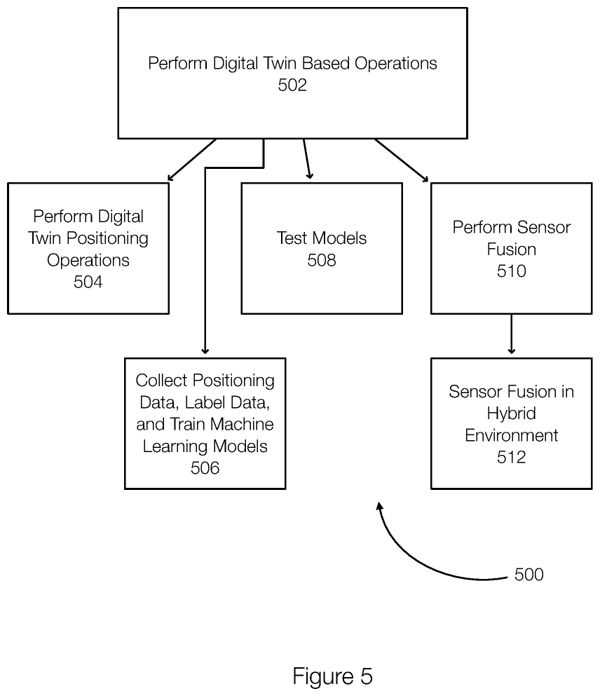

FIG. 5 discloses aspects of digital twin operations. The method 500 may include performing 502 digital twin or digital twin related operations. The services on the nodes and on the central node operate as discussed herein. Thus, a node may collect sensor data, send events to a central node, listen for events, and perform actions. The central node may similarly listen for events, update a digital twin virtual environment, send events to the nodes, and perform other actions.

In one example, the method 500 may include performing 504 digital twin positioning operations. The central node may aggregate IMU data, RFID positioning data, UWB positioning data. This information may be provided to prediction predicting models that can be replayed in a virtual environment and mitigate the impact of delayed positioning data. This may allow, for example, the predicted positions to be compared to actual positions. Alternatively, the path of a virtual only node can be predicted using the aggregated data.

In another example, data corresponding to potential collision events can be labeled 506 for training machine learning models. More specifically, the aggregated data corresponding to near collision events can be labeled as such. In another example, models can be tested 508. A virtual environment allows virtual nodes or objects to be placed in the virtual environment. This allows the ability of a machine learning model to be tested. For example, a virtual only mode may move towards another virtual node (which may correspond to a real object). Based on position readings and other sensor data from the virtual only node from the real node (or another virtual only node), the ability of a machine learning model to predict a collision event can be tested. Thus, virtual nodes can be placed in specific settings and specific environments for testing purposes.

Similarly, the digital twin virtual environment also allows zones to be delineated. Thus, real world areas, using the virtual zones, can be tied to a danger ranking. Thus, real or virtual views of a zone being entered can be displayed.

Sensor fusion can also be performed 510. Data from multiple sensors can be aggregated to produce a collective output of relevant data for downstream applications. Sensor fusion 512 in a hybrid environment may also be enabled. This allows sensor data to include the generated from virtual and real-world sensors to produce a collective output of data in the form of events.

Embodiments of the invention relate to a virtual representation of real-world devices in a space. For example, in a space such as a logistics warehouse, a variety of objects can be modeled. A digital twin or virtual warehouse has multiple uses. The virtual objects in the virtual environment may be updated at a certain frequency. The digital twin can also be used to model virtual nodes that do not have a physical association.

More specifically, the physical environment may include mobile devices that have a variety of different sensors. The virtual representation of the real-world objects allows an event-based approach to their positions or to performing logistics operations, which may include collision avoidance operations, speed changing operations, or other actions. Further, the digital twin allows events to be replayed. If a collision occurs, the data can be collected (e.g., from the database 326) and evaluated to determine whether a warning was generated, to determine why a collision was or was not predicted, or the like.

In one example, zones and rules are defined that can be applied to aggregated sensor readings and mobile device data. For example, nodes in adjacent zones may be made aware of each other. This may depend on the size of the zone. A node entering an occupied zone may be made aware of other nodes in the zone. When approaching a blind corner, a virtual or actual view of the area around the corner may be presented at a node. The rules can vary widely and may be constructed based on machine learning models.

If one goal is to prevent collisions or other issues, a digital twin allows scenarios to be tested. For example, trajectory prediction machine learning models can be tested. More generally, the digital twin allows real world devices to be mirrored and allows prediction models to be tested and/or executed to ensure that the models accurately represent real-world conditions. The digital twin can test scenarios that include different sets of rules for various devices (nodes), sensors, and their actuation. The digital twin may also be able to used trained machine learning models when generating events. Thus, warnings may be based on machine learning predictions and/or geo-zone based rules.

As previously stated in one example, it is assumed there is a zone containing 2 forklifts and a wall that obstructs the line-of-sight between the forklifts within the virtual environment (e.g., FIG. 3B). Using a digital twin, each of these forklifts can be placed in the virtual warehouse. Using readings from real world sensors, such as UWB and IMU sensors, the positioning trajectory can be tested using real and/or synthetic data. The virtual forklifts can be moved in an effort to determine if the prediction places the forklifts in a collision scenario.

By way of example only, embodiments of the invention aggregate IMU sensor data, RFID positioning data, UWB positioning data, and position predicting models which can be replayed in a virtual space, to mitigate the impact of delayed positioning data.

Further, the digital twin allows data to be captured, aggregated, and labelled for use in training machine learning models.

Embodiments of the invention also facilitate the actuation of nodes (e.g., devices or objects (real and/or virtual)). The ability to actuate devices nodes and other objects, whether real or virtual, enables a virtual replica modelling of a real-world scenario where virtual nodes or objects can be placed in specific settings within a specific environment. This allows prediction models, including collision detection models to be tested and/or validated.

Embodiments of the invention also facilitate the delineation of geo-zones, which highlight areas of increased or raised dangers. These zones serve as a virtual means of tying real-world areas to danger rankings. With sensor data from the real-world environment, the digital twin can show real or virtual zones being entered. Zones that include or are about to include more than one node may be deemed more dangerous. In some embodiments, data from multiple sensors can be aggregated to produce a collective output of data for downstream applications.

Generally, the digital twin may be configured to detect, manage, and process various scenarios including safety scenarios. Example safety scenarios include collision events, potential collision scenarios, unsafe operations, excessive speed, or the like. Scenarios may also detect safe scenarios (e.g., for employee reward/recognition or other purposes). More generally, safety scenarios are examples of logistics operations that are detected, managed, averted, controlled, tested, or the like or combination thereof.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, digital twin operations, data collection operations, position tracking operations, model testing operations, model verification operations, collision detection operations, or the like.

New and/or modified data (e.g., sensor data) collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform or provide applications, services, or the like including digital twin related services and functionality.

Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data system components such as databases, storage servers, storage volumes (LUNs), storage disks, services, backup servers, servers, for example, may likewise take the form of software, physical machines, containers, or virtual machines (VMs), though no particular component implementation is required for any embodiment.

As used herein, the term ‘data’ is intended to be broad in scope. Thus, that term embraces, by way of example and not limitation, sensor data, position data, events, display data, rendered data, or the like.

Example embodiments of the invention are applicable to any system capable of storing and handling various types of objects or other data, in analog, digital, or other form.

It is noted that any operation(s) of any of these methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: preparing sensor data at a node in a physical environment for transmission to a central node, wherein the sensor data includes position data, sending the sensor data to a message service at the central node, listening for events from the message service, and predicting a presence of a safety scenario.

Embodiment 2. The method of embodiment 1, wherein the safety scenario comprises a potential collision between the node and a second node.

Embodiment 3. The method of embodiment 1 and/or 2, wherein the event indicates that the node is entering a zone occupied by the second node.

Embodiment 4. The method of embodiment 1, 2, and/or 3, further comprising generating a display at the node associated with the event.

Embodiment 5. The method of embodiment 1, 2, 3, and/or 4, further comprising displaying a feed from a camera in a physical environment.

Embodiment 6. The method of embodiment 1, 2, 3, and/or 5, further comprising displaying a rendered environment based on a virtual environment.

Embodiment 7. A method comprising: receiving events from nodes operating in a physical environment, publishing the events to a digital twin comprising a virtual environment, aggregating the events from the nodes, determining that a probability of a safety scenario is above a threshold and constitutes a safety event, and publishing the safety event to nodes impacted by the safety event.

Embodiment 8. The method of embodiment 7, wherein the virtual environment includes a virtual node for each of the nodes.

Embodiment 9. The method of embodiment 7 and/or 8, wherein the virtual environment further includes virtual only nodes.

Embodiment 10. The method of embodiment 7, 8, and/or 9, further comprising replaying positions of nodes in the virtual environment using the virtual nodes and/or the virtual only nodes.

Embodiment 11. The method of embodiment 7, 8, 9, and/or 10, further comprising testing collision models in the digital twin and testing collision prediction models in the digital twin.

Embodiment 12. The method of embodiment 7, 8, 9, 10, and/or 11, further comprising actuating virtual sensors in the digital twin.

Embodiment 13. The method of embodiment 7, 8, 9, 10, 11, and/or 12, generating an output from sensors in the physical environment and virtual only sensors in the digital twin.

Embodiment 14. The method of embodiment 7, 8, 9, 10, 11, 12, and/or 13, further comprising defining zones in the virtual environment.

Embodiment 15. The method of embodiment 7, 8, 9, 10, 11, 12, 13, and/or 14, further comprising applying rules based on nodes entering the zones to determine that the safety scenario has occurred.

Embodiment 16. The method of embodiment 7, 8, 9, 10, 11, 12, 13, 14, and/or 15, further comprising causing a node to display an interface that includes real data from a sensor in the environment or rendered data that includes data from a virtual only sensor.

Embodiment 17. The method of embodiment 7, 8, 9, 10, 11, 12, 13, 14, 15, and/or 16, wherein the events include ultrawide band position data and/or radio frequency identifier position data and/or inertial data.

Embodiment 18. A non-transitory storage medium having stored therein instructions that are executable by one or more hardware processors to perform operations comprising the operations of any one or more of embodiments 1-17.

Embodiment 19. A method comprising any one or more of embodiments 1-17 or any portions or combinations thereof.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, client, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

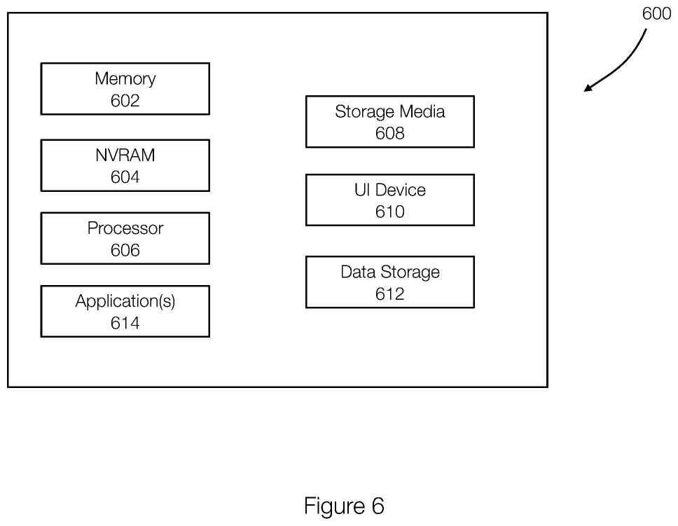

With reference briefly now to FIG. 6, any one or more of the entities disclosed, or implied, by the Figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
preparing sensor data at a node in a physical environment for transmission to a central node, wherein the sensor data includes position data;
sending the sensor data to a message service at the central node;
listening for events from the message service; and
determining a presence of a safety scenario.

2. The method of claim 1, wherein the safety scenario comprises a potential collision between the node and a second node.

3. The method of claim 2, wherein the event indicates that the node is entering a zone occupied by the second node.

4. The method of claim 1, further comprising generating a display at the node associated with the event.

5. The method of claim 4, further comprising displaying a feed from a camera in a physical environment.

6. The method of claim 5, further comprising displaying a rendered environment based on a virtual environment.

7. A method comprising:
receiving events from nodes operating in a physical environment;
publishing the events to a digital twin comprising a virtual environment;
aggregating the events from the nodes;
determining that a probability of a safety scenario is above a threshold and constitutes a safety event; and
publishing the safety event to nodes impacted by the safety event.

8. The method of claim 7, wherein the virtual environment includes a virtual node for each of the nodes.

9. The method of claim 8, wherein the virtual environment further includes virtual only nodes.

10. The method of claim 9, further comprising replaying positions of nodes in the virtual environment using the virtual nodes and/or the virtual only nodes.

11. The method of claim 7, further comprising testing collision models in the digital twin and testing collision prediction models in the digital twin.

12. The method of claim 7, further comprising actuating virtual sensors in the digital twin.

13. The method of claim 7, further comprising generating an output from sensors in the physical environment and virtual only sensors in the digital twin.

14. The method of claim 7, further comprising defining zones in the virtual environment.

15. The method of claim 14, further comprising applying rules based on nodes entering the zones to determine that the safety scenario has occurred.

16. The method of claim 15, further comprising causing a node to display an interface that includes real data from a sensor in the environment or rendered data that includes data from a virtual only sensor.

17. The method of claim 7, wherein the events include ultrawide band position data and/or radio frequency identifier position data and/or inertial data.

18. A non-transitory storage medium having stored therein instructions that are executable by one or more hardware processors to perform operations comprising: receiving events from nodes operating in a physical environment;
publishing the events to a digital twin comprising a virtual environment;
aggregating the events from the nodes;
determining that a probability of a safety scenario is above a threshold and constitutes a safety event; and
publishing the safety event to nodes impacted by the safety event.

19. The non-transitory storage medium of claim 18, wherein the virtual environment includes a virtual node for each of the nodes and virtual only nodes, further comprising: replaying positions of nodes in
the virtual environment using the virtual nodes and/or the virtual only nodes;
testing collision models in the digital twin and testing collision prediction models in the digital twin;
actuating virtual sensors in the digital twin;
generating an output from sensors in the physical environment and virtual only sensors in the digital twin;
defining zones in the virtual environment;
applying rules based on nodes entering the zones to determine that the safety scenario has occurred; and/or
causing a node to display an interface that includes real data from a sensor in the environment or rendered data that includes data from a virtual only sensor.

20. The non-transitory storage medium of claim 18, wherein the events include ultrawide band position data and/or radio frequency identifier position data and/or inertial data.
